(19) United States
(12) Patent Application Publication
(10) Pub. No.: US 2019/0097819 A1
(43) Pub. Date: Mar. 28, 2019

(54) System and Method for Determining the Relative Timing of Events Occurring in Geographically Disparate Locations

(71) Applicant: William E. Woodcock, IV, Berkeley, CA (US)

(72) Inventor: William E. Woodcock, IV, Berkeley, CA (US)

(21) Appl. No.: 16/145,159

(22) Filed: Sep. 27, 2018

Related U.S. Application Data
(60) Provisional application No. 62/563,887, filed on Sep. 27, 2017.

(51) Int. Cl. H04L 9/32; G06F 17/30; H04L 9/06; H04L 9/30

(52) U.S. Cl. CPC H04L 9/3297; G06F 17/30241; H04L 9/30; H04L 9/0637; H04L 9/3247

(57) ABSTRACT

A system and method for determining the relative timing of geographically-distributed events. Each of a plurality of geographically-distributed nodes has a location, a public-key cryptographic signing mechanism, a storage system, and a network interface. Each node maintains a blockchain comprising a chain of sequential, cryptographically-signed blocks. A first block of data is received at a first node, and a second block of data is received at a second node. The blocks of data are cryptographically signed by operation of the public-key cryptographic signing mechanisms with a timestamp based on an accurate time source, the location and a hash of the blockchain of the respective node to form first and second user events. The nodes can generate periodic ticks to bracket user events. The first and second user events are inserted into the blockchains of the nodes, and the timestamps of the user events can be compared to determine event priority.

### RELATED APPLICATION

This application claims the benefit of Provisional Application No. 62/563,887, filed Sep. 27, 2017, which is incorporated herein by reference.

### FIELD OF THE INVENTION

The present invention relates generally to systems and methods for verifying the timing and relative timing of events in geographically disparate locations. More particularly, disclosed and protected herein are a system and method for electronically determining and verifying the timing and relative timing of events occurring in geographically disparate locations with localized and synchronized time determination.

### BACKGROUND OF THE INVENTION

The relative timing of related events is often critical. However, such related events often occur in geographically distant locations. By way of example and not limitation, the precise timing and relative priority of stocks and commodity transactions potentially occurring in locations significantly spaced from one another geographically can produce tremendous financial impacts on the participants. For instance, fluctuations and volatility in the stock and commodities markets, where purely financial trades increasingly outnumber physical trades in which goods are actually delivered, cause the precise timing and relative timing of sales, purchases, and other transactions, potentially triggered from geographically disparate locations on the globe, to be critical.

However, there is an inherent temporal delay in propagating information between and in relation to different geographic locations. For instance, the speed of light through fiber produces signal transmission delay that is large in relation to the temporal resolution of certain events, including but not limited to funds and other financial transactions. Consequently, if event A happens in a first location and event B simultaneously happens in a second location, both events may be recorded to determine their timing and relative timing. However, based on the temporal delay of information propagation, the first location may record the events as occurring as A followed by B while the second location may record the events as occurring as B followed by A, despite the simultaneous occurrence of events A and B. Other permutations are possible, but the underlying reality is that, under the prior art, the perceived timing and priority of events can be distorted by the location from which that relative timing and priority are determined.

Furthermore, bearing in mind that the temporal delay is stochastic and not uniformly predictable, the distortion of the perceived timing and priority of events is not readily accommodated or solved. The existence of malicious actors further complicates resolution of the inherent, stochastic delays since such parties may seek to disrupt the system or interpose false information. Indeed, financially-incentivized malicious actors are known to seek to falsify the results of distributed systems of linked computers. Particularly in combination, such possible acts of malfeasance and unpredictable delays complicate the determination of the timing and priority of events, even where one is in possession of currently available types of information after the events have concluded.

It will thus be understood that there is a need for a system and method for determining and verifying the timing and relative timing of events occurring in geographically disparate locations. It will be further understood that the need for determining the timing and relative timing of events exists for signals even apart from those determined and verified over the Internet as a signaling system.

### SUMMARY OF THE INVENTION

With an awareness of the foregoing, the present inventor set forth with the fundamental object of enabling the determination and verification of the timing and relative timing of events occurring in geographically disparate locations.

A more particular object of embodiments of the invention is to enable the determination and verification of the timing and relative timing of events occurring in geographically disparate locations that are connected by communications networks exhibiting stochastic delay and potential attacks by malicious actors seeking to disrupt the system or to interpose false information.

An underlying object of the invention is to provide a system and method for determining and verifying the timing and relative timing of events occurring in geographically disparate locations thereby to ensure, among other things, accurate event priority and to minimize the occurrence and deleterious effects of incorrect event timing and priority determinations.

Another object and potential advantage of the invention is to protect against or provide an indication of compromises in cryptography at given locations by exposing localized anomalies published by such locations that are incompatible with events recorded at other locations.

These and further objects and advantages of the present invention will become obvious not only to one who reviews the present specification and drawing but also to those who have an opportunity to experience an embodiment of the geographically-distributed system and method for determining the timing and relative timing of events disclosed herein in operation. However, it will be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

In one practice of the system and method for determining the relative timing of geographically distributed events, a system comprising a plurality of nodes is provided. The nodes are geographically-distributed, each node comprising a public-key cryptographic signing mechanism, a storage system, and a network interface. Each node has a location, and an accurate time source is provided for each node. The accurate time source could, for example, be an atomic clock or other accurate time source in communication with the node. For each node, a blockchain is maintained comprising a chain of sequential, cryptographically-signed blocks. Each block in the blockchain refers to an immediately-preceding block.

Pursuant to the method, a first block of data communicated by a user is received at a first node of the plurality of nodes. The first block of data is cryptographically signed by operation of the public-key cryptographic signing mechanism of the first node with a timestamp provided by the accurate time source in communication with the first node, the location of the first node, and a hash of the blockchain of the first node to form a first event. The first event is inserted into the blockchain of the first node. In a similar manner, a second block of data communicated from a user is received at a second node of the plurality of nodes, and the second block of data is cryptographically signed by operation of the public-key cryptographic signing mechanism of the second node with a timestamp of reception of the second block of data provided by the accurate time source in communication with the second node, the location of the second node, and a hash of the blockchain of the second node to form a second event. The second event is inserted into the blockchain of the second node. With that, the timestamps of the first and second events can be compared to determine a priority of the first and second events.

Pursuant to a practice of the method, a first block of data communicated by a user is again received at a first node of the plurality of nodes. The first block of data is cryptographically signed by operation of the public-key cryptographic signing mechanism of the first node with a timestamp provided by the accurate time source in communication with the first node, the location of the first node, and a hash of the immediately preceding event in the blockchain of the first node to form a first event. The first event is inserted into the blockchain of the first node. The first event is then transmitted to one or more other nodes of the plurality of nodes. Upon receipt at another node, such as a second node, the first event is treated as a block of data. It is cryptographically signed by operation of the public-key cryptographic signing mechanism of the second node with a timestamp provided by the accurate time source in communication with the second node, the location of the second node, and a hash of the immediately preceding event in the blockchain of the second node to form a second, encapsulating event. In such practices, the encapsulating event, in the blockchain of the second node, thus completely encapsulates the first event, providing an indelible record of its receipt at the second node. With that, the timestamps of the first and second events can be compared with the propagation delay between the first and second nodes to determine a priority of the first and second events.

In practices of the invention, data received from a user at a first node and data received from a user at a second node will typically be from different users. Specifically, due to the workings of anycast, the data received at the first node will be from a user relatively proximate to the first node while the data received from a user at the second node will be from a user relatively proximate to the second node. Nonetheless, it is recognized that, due to fluctuations in Internet routing, it is rare but possible that the same user might be deemed proximate to the first node in one instant yet closer to the second node a moment later.

In practices of the method, data regarding the first and second events is transmitted to nodes of the plurality of nodes other than the first and second nodes. The data regarding the first and second events can, for instance, include a cryptographic signature, a timestamp of the event, and the location of the node.

It is further contemplated that tick events can be generated periodically at each node of the plurality of nodes. The tick events can be transmitted to one or more other nodes within the system. With that, the ticks can bracket the events formed by the blocks of data received from users.

In embodiments of the system and method, each node can have two logical interfaces with a first logical interface comprising a common address for utilizing anycast routing and a second, unique public address uniquely associated with that node for communicating with that node specifically.

A system for determining the relative timing of geographically distributed events can thus be founded on a plurality of nodes that are geographically distributed. Each node comprises a public-key cryptographic signing mechanism, a storage system, and a network interface, and each node has a location. Each node is operative to maintain a blockchain comprising a chain of sequential, cryptographically-signed blocks wherein each block refers to an immediately-preceding block. For each node, an accurate time source is provided in communication with the node, and each node of the plurality of nodes maintains a knowledge of its own geographic location.

A first node of the plurality of nodes is operative to receive a first block of data communicated from a user, to sign the first block of data cryptographically by operation of the public-key cryptographic signing mechanism of the first node with a timestamp of reception of the first block of data provided by the accurate time source in communication with the first node, the location of the first node, and a hash of an immediately-preceding block of the blockchain of the first node to form a first event and to insert the first event into the blockchain of the first node. A second node of the plurality of nodes is operative to receive a second block of data communicated from a user, to sign the second block of data cryptographically by operation of the public-key cryptographic signing mechanism of the second node with a timestamp of reception of the second block of data provided by the accurate time source in communication with the second node, the location of the second node, and a hash of an immediately-preceding block of the blockchain of the second node to form a second event and to insert the second event into the blockchain of the second node.

While other interfaces are possible, the network interface for each node of the plurality of nodes can comprise a connection to the Internet. The system can be accessible through a shared anycast address. In particular embodiments, each node of the plurality of nodes has two public logical interfaces wherein a first public logical interface shares an address in common with other nodes and wherein a second public logical interface has a unique public address that is uniquely associated with that node. In such embodiments, each node of the plurality of nodes can publish the blockchain of that node on the unique public address of that node. Moreover, each node of the plurality of nodes can have a unique private address.

Within the scope of the invention, the time sources in communication with the nodes of the plurality of nodes can comprise synchronized clocks with at least one clock disposed coincident with or geographically near each respective node. The first and second nodes can be further operative to transmit data regarding the first and second events to nodes other than the first and second nodes. For example, the data regarding the first and second events can include a cryptographic signature, a timestamp of the event, and the location of the node.

One will appreciate that the foregoing discussion broadly outlines the more important goals and certain features of the invention to enable a better understanding of the detailed description that follows and to instill a better appreciation of the inventor's contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF DRAWINGS

In the accompanying drawing figures:

FIG. 1 is a schematic view of the determination and verification of the timing and relative timing of events occurring in geographically disparate locations that are connected by communications networks as taught herein;

FIG. 2 is a further schematic view of the determination and verification of the timing and relative timing of events occurring in geographically disparate locations that are connected by communications networks according to the invention; and

FIG. 3 is a schematic view of the determination and verification of the timing and relative timing of events occurring in geographically disparate locations that are connected by communications networks as taught herein with a depiction of the propagation of tick events according to the present system and method.

### DETAILED DESCRIPTION OF PREFERRED EMBODIMENTS

Systems and methods for determining the timing and relative timing of events occurring in geographically disparate locations as disclosed herein can pursue a wide variety of embodiments, each within the scope of the invention. However, to ensure that one skilled in the art will be able to understand and, in appropriate cases, practice the present invention, certain preferred embodiments and aspects of the broader invention revealed herein are described below and shown in the accompanying drawing figure. The timing and relative timing of events in geographically disparate locations may at times be described herein as being used in relation to signals propagated using the Internet as a signaling system, but the present invention shall not be considered to be so limited except as may be expressly provided for in the claims.

In one particular embodiment, the system and method for determining the relative timing of geographically distributed events can be carried forth by a system of coordination between geographically distributed blockchains. The blockchains act as timestamping mechanisms operating in parallel to facilitate timestamping and an accurate determination of relative timing and, if and as applicable, priority between the geographically distributed events. The system can be characterized to include a plurality of blockchains operative in parallel in different locations. The blockchains can be considered to be interlocking. The blockchain timestamping mechanisms function to overcome the deleterious effects of temporal delays deriving from propagating information between locations, such as due to the limitations deriving from, for example but not limitation, the speed of light through fiber, which can be large in comparison to the temporal resolution of the events within each blockchain.

Pursuant to an embodiment of the system and method, synchronized clocks are disposed with at least one clock at or relatively geographically near each location. Localized timestamping by reliance on the synchronized clocks is then undertaken. The localized timestamping can reflect or otherwise accommodate the typical, predicted, or actual propagation delay in each direction between the locations. Operating as disclosed herein, a system and method can accurately determine and record the actual order of events, even events occurring in close temporal range. The disclosed system and method can operate to avoid incorrectly giving a given event priority in relation to another event or other events based on, for example, the proximity of the given event in relation to the other event or events.

The system and method for determining the timing and relative timing of events occurring in geographically disparate locations can, in particular manifestations, employ blockchains to carry out timestamping in coordination with local, synchronized accurate time sources. An accurate time source could, by way of example and not limitation, comprise an atomic clock. The atomic clock or other accurate time source could be disciplined by synchronization with other accurate time sources, such as other atomic clocks.

As set forth hereinabove, the system and method for determining the relative timing of geographically distributed events can be operative with a coordination between geographically distributed blockchains with it being understood that other manifestations are possible. In relation to embodiments employing geographically distributed blockchains, it will be noted that a blockchain is a data structure that stores a list of events thereby to operate as an electronic ledger. The electronic ledger records events, or tokens, or representations of them. The events, or tokens, or representations of them are containerized in what are referred to as blocks. Each block also contains a current timestamp and the hash of the prior block, and each block after the first block refers back to or is linked to the prior block in the chain. A computer maintains each blockchain and cryptographically signs each new block. As a consequence, an unbreakable chain of sequential, cryptographically-signed blocks is built. Each block refers directly to the immediately preceding block and indirectly to all preceding blocks. In this way, precedence and order are established in a cryptographically-verifiable way that is extraordinarily resistant to subsequent tampering or falsification.

The integrity of the blockchain is maintained in that each block refers to or includes a cryptographic hash value of the prior block. Since any modification to a block will change the hash value of the block, it is difficult to modify or tamper with a block referenced by a subsequent block. The contents of the blockchain can be published to permit public inspection and verification. By being subjected to this public inspection and verification, the contents of the blockchain become immutable in practice. Each event effectively locks in the preceding event so that only the last event in the chain is ephemerally unprotected, and a further event soon after the previously-unprotected event quickly renders it protected as no longer being the last event.

The system as taught herein can incorporate geographically-distributed, functionally-identical subsystems, which may be referred to as nodes. Each node can include a cryptographic signing mechanism, such as a Trusted Platform Module (TPM) and/or a Hardware Security Module (HSM), an accurate time source, a storage system, and a network interface. In certain embodiments, the storage system could include, among other things, a file system that is publicly readable, but not writeable, such as from the Internet. The network interface could be carried forth through a connection to the Internet. It will again be noted, however, that the present invention is not limited to application through the Internet except as the claims may expressly require.

The system and the method for using the system for determining the timing and relative timing of events occurring in geographically disparate locations can incorporate mechanisms and practices for facilitating secure communications between nodes. For instance, communication between nodes may be protected by transport layer security. The transport layer security can include cryptographic authentication of the corresponding node, which can prevent attacks on communications between the nodes. For instance, such security and authentication can prevent what are commonly referred to as man-in-the-middle attacks where an attacker seeks to make independent connections with victims and to relay messages between them to make them believe they are communicating directly over a private connection while the communications are actually routed through the attacker. The routing of traffic between nodes could additionally or alternatively be protected by a routing security mechanism, such as by use of an Internet Routing Registry or a Routing Public Key Infrastructure, each operating to prevent the diversion of traffic between nodes.

Other mechanisms and practices may be employed to maintain cryptographic strength against attacks or to remedy weaknesses. For example, there may be a publication of events by nodes onto the blockchains of other nodes with periodic, scheduled, or emergency, changes of cryptographic keys or algorithms. Such practices would introduce further resistance to attack on the system.

In one implementation, each node could possess two public logical interfaces, such as two IP addresses. A first public logical interface or address could share a common address utilizing anycast routing to provide users with transparent, fail-over redundancy to distribute loads between nodes and to provide users with service from the node likely to be reachable by them with the lowest propagation latency. The second address could be uniquely associated with that node and could be used to communicate with that node specifically.

Operating under the disclosed system, each node would maintain its own blockchain and publish it on its unique public IP address. Each node may also possess a unique private address with independent network connectivity. The private addresses can facilitate communications between nodes. With that, normal or attack traffic directed to a node's public address would not impede or delay communications between nodes.

Each node can maintain a knowledge of its own geographic location. For instance, each node can maintain an electronic record of its own geographic location. Moreover, each node can be responsive to the efforts of third parties to verify the node's geographic location by replying to round-trip ping measurements. Where the requestor receives the node's reply sufficiently quickly based on the ping measurement, the node can effectively prove that it cannot be distant from the origin of the measurement since its reply cannot exceed the speed of light.

In practice, a user of the system would typically communicate data comprising an event to a node, typically a topologically-nearest node. The node can be reached via the shared anycast public address. Upon reception by a node, the block of data or its hash, the precise time of its reception, the location of the node, and the hash of that node's blockchain's immediately-preceding event would be cryptographically signed. An event, which may be referred to as a user event, is thus formed, and that event is inserted into that node's blockchain and published, such as via the node's storage mechanism, for public inspection and verification. Pursuant to the disclosed system, the anycast address can be used not only for locating what is typically the topologically-nearest node but also, in a more complex implementation, for nodes to perform topology exploration, discovering other nearby nodes to which events can be suitably sent.

Upon entering an event in its own blockchain, a node may also transmit a copy of that event to one or more other nodes. In a small or lightly-used system, it may transmit to all other nodes in the system. In a large or heavily-used system, a subset of nodes may be selected for receiving a transmission of the event. The subset could be relatively unchanging as, for example, if it is the subset of most proximate or most available nodes. Alternatively, the subset could be a subsampling of the whole system, purposely including each other node in the system with relatively uniform frequency, or the subset could comprise the least-heavily-utilized nodes. Still further, the subset could be determined by a combination of these or other selection methods.

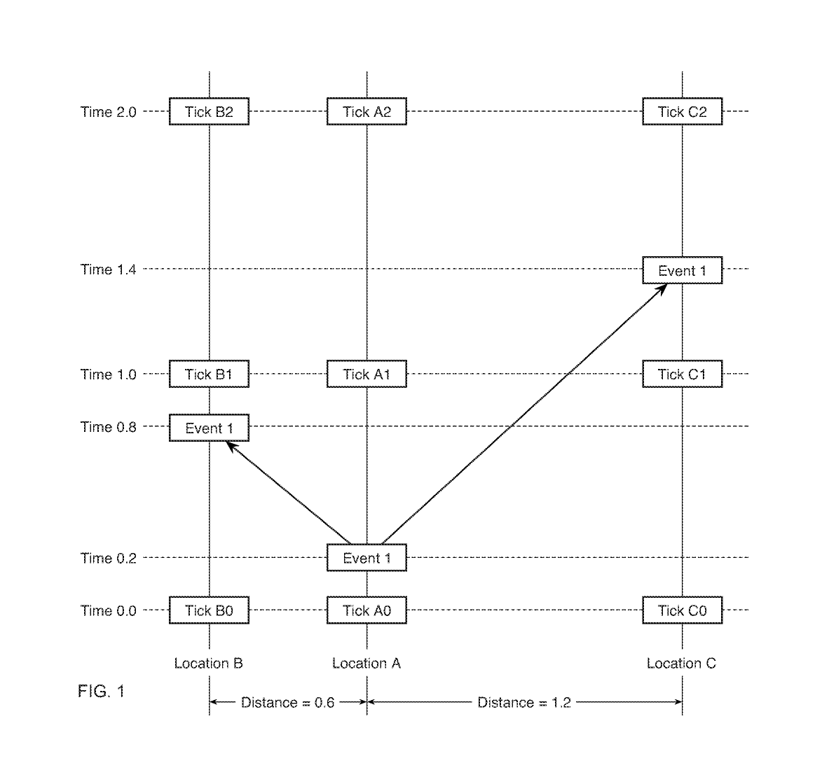

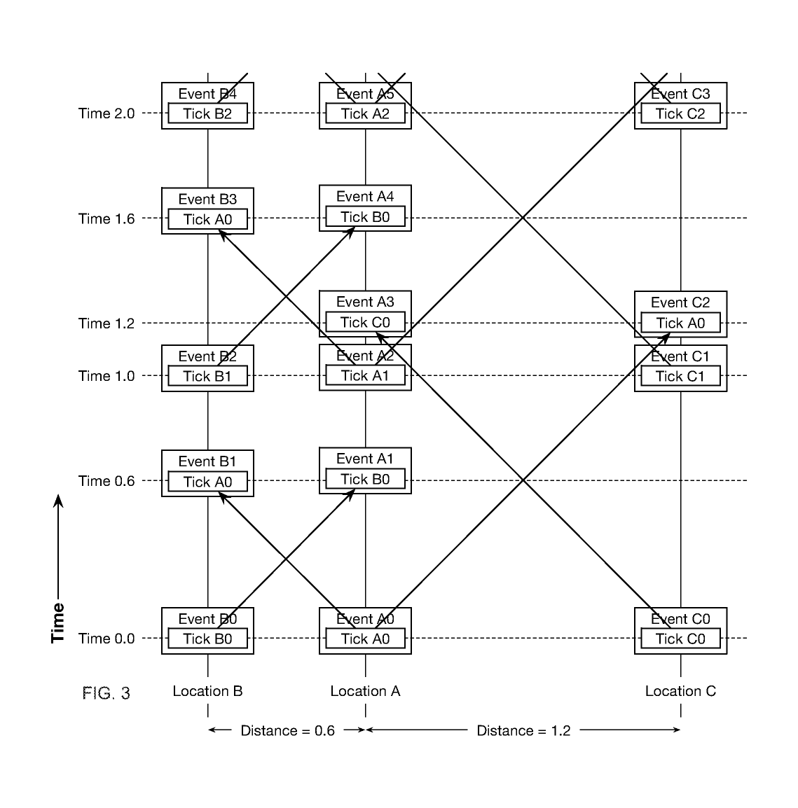

In addition to timestamping events as they are received from external users and other nodes, the system can also include, as shown in the example of FIGS. 1, 2 and 3, what are referred to as tick events or ticks. The tick events could, for example, be system clock tick events denoting the passage of a unit of time. The tick events can be of regular periodicity and could be generated on each node. The regular ticks can narrowly bracket each user event and/or other tick events by limiting the window of time in which events could be timestamped and reducing the number of events that could be timestamped in a different order than received. If these tick events are frequent enough, a tick event, a user event, and a subsequent tick event may all be signed and published before news of any of them propagated as far as other users. This would provide some degree of security against the falsification of events at other nodes in reaction to the signed event at the first node.

Depending on, for example, the available capacity of the system, the number of nodes, and the volume of user-originated events already being passed between nodes, tick events may also be passed between nodes thereby providing a continually-established latency baseline between node pairs. As the node-pair latency baseline becomes well established over time, it can be used to verify the geographic locations of nodes and to detect anomalies, such as any movement of a node. Also, as the node-pair latency baseline becomes established, it can be used to identify any events that appear to arrive from other nodes but arrive too soon or uncharacteristically late.

Thus, pursuant to a practice of the method, a first block of data communicated by a user is received at a first node of the plurality of nodes. The first block of data is cryptographically signed by operation of the public-key cryptographic signing mechanism of the first node with a timestamp provided by the accurate time source in communication with the first node, the location of the first node, and a hash of the blockchain of the first node to form a first event. The first event is inserted into the blockchain of the first node. In a similar manner, a second block of data communicated from a user is received at a second node of the plurality of nodes, and the second block of data is cryptographically signed by operation of the public-key cryptographic signing mechanism of the second node with a timestamp of reception of the second block of data provided by the accurate time source in communication with the second node, the location of the second node, and a hash of the blockchain of the second node to form a second event. The second event is inserted into the blockchain of the second node. With that, the timestamps of the first and second events can be compared to determine a priority of the first and second events.

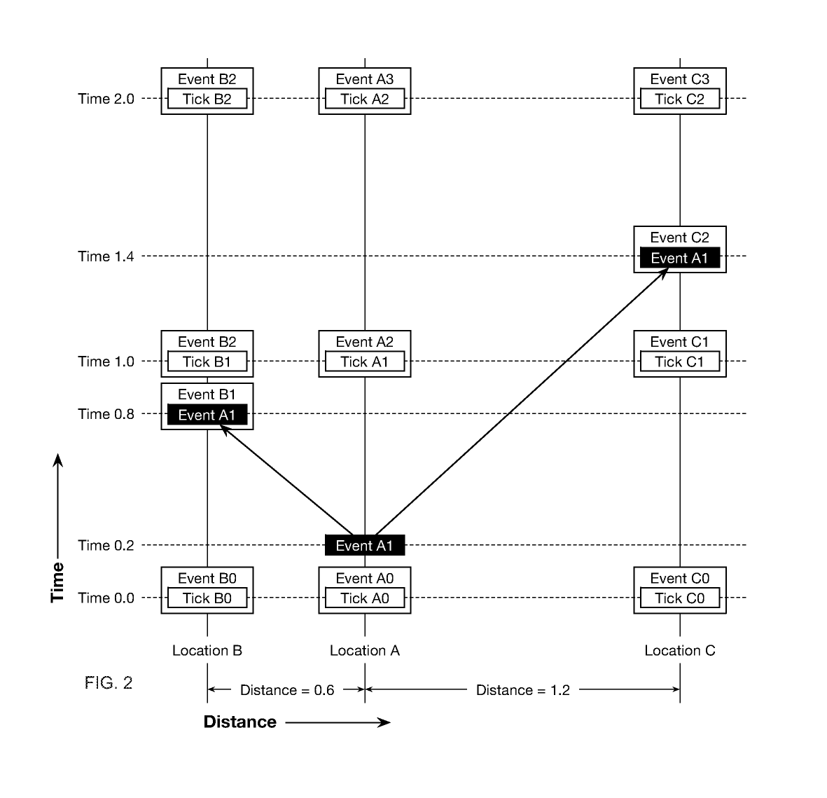

Also pursuant to a practice of the method, as FIG. 2 illustrates, for example, a first block of data communicated by a user is again received at a first node of the plurality of nodes. The first block of data is cryptographically signed by operation of the public-key cryptographic signing mechanism of the first node with a timestamp provided by the accurate time source in communication with the first node, the location of the first node, and a hash of the immediately preceding event in the blockchain of the first node to form a first event. The first event is inserted into the blockchain of the first node. The first event is then transmitted to one or more other nodes of the plurality of nodes. Upon receipt at another node, such as a second node, the first event is treated as a block of data. It is cryptographically signed by operation of the public-key cryptographic signing mechanism of the second node with a timestamp provided by the accurate time source in communication with the second node, the location of the second node, and a hash of the immediately preceding event in the blockchain of the second node to form a second, encapsulating event. In such practices, the second event, in the blockchain of the second node, thus completely encapsulates the first event, providing an indelible record of its receipt at the second node. With that, the timestamps of the first and second events can be compared with the propagation delay between the first and second nodes to determine a priority of the first and second events.

To assure users that the blockchain has not been re-written from an event, such as a user event, nodes may also transmit copies of events to blockchain systems or public archives that are under separate and independent management. Additionally or alternatively, nodes can publish events in a write-once format. Additional or alternative methods for verification that a blockchain has not been rewritten may be employed.

Embodiments of the system additionally provide an indication of actual or potential compromises in cryptography at given locations. More particularly, the system can expose localized anomalies published by such locations that are incompatible with events recorded at other locations. Such localized anomalies provide an indication that the location providing anomalous results may have been compromised, even where the cryptographic signature of the location continues to validate properly. Furthermore, where the locations are sufficiently geographically distributed, such as in different countries, the possibility of even an entire local government compromising the system is minimized since succeeding in compromising the entire system would require compromising a majority of locations, including locations in areas outside of the government's control or sway. The expected tick events referenced above provide further indications of locations potentially going offline or otherwise being tampered with or disrupted.

According to the embodiments of the invention, cryptographic functions can be performed, by way of example and not limitation, by using a Trusted Platform Module or TPM and/or a Hardware Security Module. A Hardware Security Module can retain a Trusted Platform Module.

Such Trusted Platform Modules or Hardware Security Modules can operate to hold cryptographic keys and to immediately and irretrievably erase them upon any suspicion of tampering.

With certain details and embodiments of the present invention for systems and methods for determining the timing and relative timing of events occurring in geographically disparate locations disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims shall define the scope of protection to be afforded to the inventor. Those claims shall be deemed to include equivalent constructions insofar as they do not depart from the spirit and scope of the invention. It must be further noted that a plurality of the following claims may express, or may be interpreted to express, certain elements as means for performing a specific function, at times without the recital of structure or material. As the law demands, any such claims shall be construed to cover not only the corresponding structure and material expressly described in this specification but also all equivalents thereof.

I claim as deserving the protection of Letters Patent:

1. A method for determining the relative timing of geographically distributed events, the method comprising:
providing a system comprising a plurality of nodes wherein the plurality of nodes are geographically-distributed wherein each node comprises a public-key cryptographic signing mechanism, a storage system, and a network interface and wherein each node has a location;
providing for each node an accurate time source in communication with the node;
maintaining for each node a blockchain comprising a chain of sequential, cryptographically-signed blocks wherein each block refers to an immediately-preceding block;
receiving at a first node of the plurality of nodes a first block of data communicated from a user;
cryptographically signing the first block of data by operation of the public-key cryptographic signing mechanism of the first node with a timestamp of reception of the first block of data provided by the accurate time source in communication with the first node, the location of the first node, and a hash of the blockchain of the first node to form a first user event;
inserting the first user event into the blockchain of the first node;
receiving at a second node of the plurality of nodes a second block of data communicated from a user;
cryptographically signing the second block of data by operation of the public-key cryptographic signing mechanism of the second node with a timestamp of reception of the second block of data provided by the accurate time source in communication with the second node, the location of the second node, and a hash of the blockchain of the second node to form a second user event;
inserting the second event into the blockchain of the second node.

2. The method of claim 1 further comprising transmitting data regarding the first and second user events to nodes other than the first and second nodes.

3. The method of claim 2 wherein the data regarding the first and second user events includes a cryptographic signature, a timestamp of the event, and the location of the node.

4. The method of claim 1 further comprising generating tick events periodically at each node of the plurality of nodes.

5. The method of claim 4 further comprising transmitting the tick events to one or more other nodes within the system.

6. The method of claim 1 further comprising comparing the timestamps of the first and second user events to determine a priority of the first and second user events.

7. The method of claim 1 wherein the accurate time source in communication with each node comprises an atomic clock.

8. The method of claim 1 wherein each node has two logical interfaces with a first logical interface comprising a common address for utilizing anycast routing and a second, unique public address uniquely associated with that node for communicating with that node specifically.

9. The method of claim 1 wherein the first user event is transmitted from the first node to a second node of the plurality of nodes, wherein the first user event is cryptographically signed by operation of the public-key cryptographic signing mechanism of the second node with a timestamp provided by the accurate time source in communication with the second node, the location of the second node, and a hash of the immediately preceding event in the blockchain of the second node to form an encapsulating user event whereby the encapsulating user event, in the blockchain of the second node, thus completely encapsulates the first event, providing an indelible record of its receipt at the second node.

10. A system for determining the relative timing of geographically distributed events, the system comprising:
a plurality of nodes wherein the plurality of nodes are geographically distributed wherein each node comprises a public-key cryptographic signing mechanism, a storage system, and a network interface and wherein each node has a location and wherein each node is operative to maintain a blockchain comprising a chain of sequential, cryptographically-signed blocks wherein each block refers to an immediately-preceding block;
for each node, an accurate time source in communication with the node;
wherein a first node of the plurality of nodes is operative to receive a first block of data communicated from a user, to sign the first block of data cryptographically by operation of the public-key cryptographic signing mechanism of the first node with a timestamp of reception of the first block of data provided by the accurate time source in communication with the first node, the location of the first node, and a hash of an immediately-preceding block of the blockchain of the first node to form a first user event and to insert the first user event into the blockchain of the first node; and
wherein a second node of the plurality of nodes is operative to receive a second block of data communicated from a user, to sign the second block of data cryptographically by operation of the public-key cryptographic signing mechanism of the second node with a timestamp of reception of the second block of data provided by the accurate time source in communication with the second node, the location of the second node, and a hash of an immediately-preceding block of the blockchain of the second node to form a second user event and to insert the second user event into the blockchain of the second node.

11. The system of claim 10 wherein the network interface for each node of the plurality of nodes comprises a connection to the Internet.

12. The system of claim 10 wherein the system is accessible through a shared anycast address.

13. The system of claim 10 wherein each node of the plurality of nodes has two public logical interfaces wherein a first public logical interface shares an address in common with other nodes and wherein a second public logical interface has a unique public address that is uniquely associated with that node.

14. The system of claim 13 wherein each node of the plurality of nodes publishes the blockchain of that node on the unique public address of that node.

15. The system of claim 14 wherein each node of the plurality of nodes has a unique private address.

16. The system of claim 10 wherein each node of the plurality of nodes maintains a knowledge of its own geographic location.

17. The system of claim 10 wherein the time sources in communication with the nodes of the plurality of nodes comprise synchronized clocks disposed coincident with or geographically near each respective node.

18. The system of claim 10 wherein the first and second nodes are further operative to transmit data regarding the first and second user events to nodes other than the first and second nodes.

19. The system of claim 18 wherein the data regarding the first and second events includes a cryptographic signature, a timestamp of the event, and the location of the node.

20. The system of claim 10 wherein each node of the plurality of nodes is further operative to generate tick events periodically at that node of the plurality of nodes.

21. The system of claim 20 wherein each node of the plurality of nodes is further operative to transmit the tick events to one or more other nodes within the system.

22. The system of claim 10 wherein the system is operative to compare the timestamps of the first and second user events to determine a priority of the first and second user events.

23. The system of claim 10 wherein the accurate time source in communication with each node comprises an atomic clock.

24. The system of claim 10 each node of the plurality of nodes is operative to transmit the first user event is transmitted from the first node to a second node of the plurality of nodes, to sign the first user event cryptographically by operation of the public-key cryptographic signing mechanism of the second node with a timestamp provided by the accurate time source in communication with the second node, the location of the second node, and a hash of the immediately preceding event in the blockchain of the second node to form an encapsulating user event whereby the encapsulating user event, in the blockchain of the second node, thus completely encapsulates the first event, providing an indelible record of its receipt at the second node.
